(19) United States
(12) Patent Application Publication
(10) Pub. No.: US 2024/0013275 A1
(43) Pub. Date: Jan. 11, 2024

(54) Recommendation Filtering

(71) Applicant: S&P Global Inc., New York, NY (US)

(72) Inventors: Arpit Agrawal, Eurugram (IN); Ramendra Singla, Coimbatore (IN)

(21) Appl. No.: 17/811,210

(22) Filed: Jul. 7, 2022

(51) Int. Cl. G06Q 30/06; G06Q 30/02

(52) U.S. Cl. CPC G06Q 30/0631; G06Q 30/0205; G06Q 30/0201

(57) ABSTRACT

Recommendation filtering is provided. The method comprises creating a user feature matrix that cross-references users with user attributes and items and creating a user similarity matrix of user similarities according to the user attributes. Nearest neighbors of the users are then determined based the user similarities. The system creates a user-item matrix is that cross-references the users with the items, wherein the user-item matrix identifies users who use the item and users who do not use the items. The user-item matrix is multiplied by a penalizing factor for users who do not use the items. A top N number of the items is recommended to a new user based on the item scores according to user attributes of the new user.

### BACKGROUND INFORMATION

### 1. Field

The present disclosure relates generally to computer modeling, and more specifically to a method of matching items to prospective users according to similarities to past users.

### 2. Background

Product recommendations are often generated according to user similarities. To determine affinity between users, user attributes are examined, and products are recommended based on the collective weight of products offered to/bought by K nearest neighbors.

Many recommendation engines are based on collaborative and content-based filtering. Some deep learning techniques such as neural collaborative filtering use concepts of matrix factorization and neural networks to provide recommendations.

### SUMMARY

An illustrative embodiment provides a computer-implemented method for recommendation filtering. The method comprises creating a user feature matrix that cross-references a number of users with a number of user attributes and items and creating a user similarity matrix of user similarities according to the user attributes. Nearest neighbors of the users are then determined based the user similarities. The system creates a user-item matrix is that cross-references the users with the items, wherein the user-item matrix identifies users who use the item and users who do not use the items. The user-item matrix is multiplied by a penalizing factor for users who do not use the items. The user-item matrix is multiplied with subsets of the similarity matrix to calculate item scores for each user, wherein the subsets of the similarity matrix comprise the nearest neighbors of the users. A top N number of the items is recommended to a new user based on the item scores according to user attributes of the new user.

Another illustrative embodiment provides a system for recommendation filtering. The system comprises a storage device configured to store program instructions and one or more processors operably connected to the storage device and configured to execute the program instructions to cause the system to: create a user feature matrix that cross-references a number of users with a number of user attributes and items; create a user similarity matrix of user similarities according to the user attributes; determine nearest neighbors of the users based the user similarities; create a user-item matrix that cross-references the users with the items, wherein the user-item matrix identifies users who use the item and users who do not use the items; multiply the user-item matrix by a penalizing factor for users who do not use the items; multiply the user-item matrix with subsets of the similarity matrix to calculate item scores for each user, wherein the subsets of the similarity matrix comprise the nearest neighbors of the users; and recommend a top N number of the items to a new user based on the item scores according to user attributes of the new user.

Another illustrative embodiment provides a computer program product for recommendation filtering. The computer program product comprises a computer-readable storage medium having program instructions embodied thereon to perform the steps of: creating a user feature matrix that cross-references a number of users with a number of user attributes and items; creating a user similarity matrix of user similarities according to the user attributes; determining nearest neighbors of the users based the user similarities; creating a user-item matrix that cross-references the users with the items, wherein the user-item matrix identifies users who use the item and users who do not use the items; multiplying the user-item matrix by a penalizing factor for users who do not use the items; multiplying the user-item matrix with subsets of the similarity matrix to calculate item scores for each user, wherein the subsets of the similarity matrix comprise the nearest neighbors of the users; and recommending a top N number of the items to a new user based on the item scores according to user attributes of the new user.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a recommendation filtering system depicted in accordance with an illustrative embodiment;

FIG. 3 depicts a diagram of a user feature matrix in accordance with an illustrative embodiment;

FIG. 4 depicts a diagram of a user similarity matrix in accordance with an illustrative embodiment;

FIG. 5 depicts a diagram of a user-item matrix in accordance with an illustrative embodiment;

FIG. 6 depicts application of a penalizing factor to the user-item matrix in accordance with an illustrative embodiment;

FIG. 7 depicts a diagram of product score matrix in accordance with an illustrative embodiment;

FIG. 8 depicts charts illustrating hit ratios for different values of penalizing factor and nearest neighbors;

FIG. 9 depicts a diagram of a filtering algorithm in accordance with an illustrative embodiment;

FIG. 10 depicts a flowchart illustrating a process for recommendation filtering in accordance with an illustrative embodiment; and

FIG. 11 is a block diagram of a data processing system in accordance with an illustrative embodiment.

### DETAILED DESCRIPTION

The illustrative embodiments recognize and take into account one or more different considerations. The illustrative embodiments recognize and take into account that product recommendations are often generated according to user similarities. To determine affinity between users, user attributes are examined, and products are recommended based on the collective weight of products offered to/bought by K nearest neighbors.

The illustrative embodiments also recognize and take into account that prior recommendation techniques do not account for negative feedback of lost opportunities for new or current, “on-book” customers/users. For example, current platforms consider users who are part of the platform to recommendation products using similar behavior but do not account for the customers who already stopped using the platform.

The illustrative embodiments provide a method of filtering product recommendation that incorporates negative feedback. The illustrative embodiments not only use data for converted opportunities but also for lost opportunities by using a penalizing factor that handled implicit negative feedback.

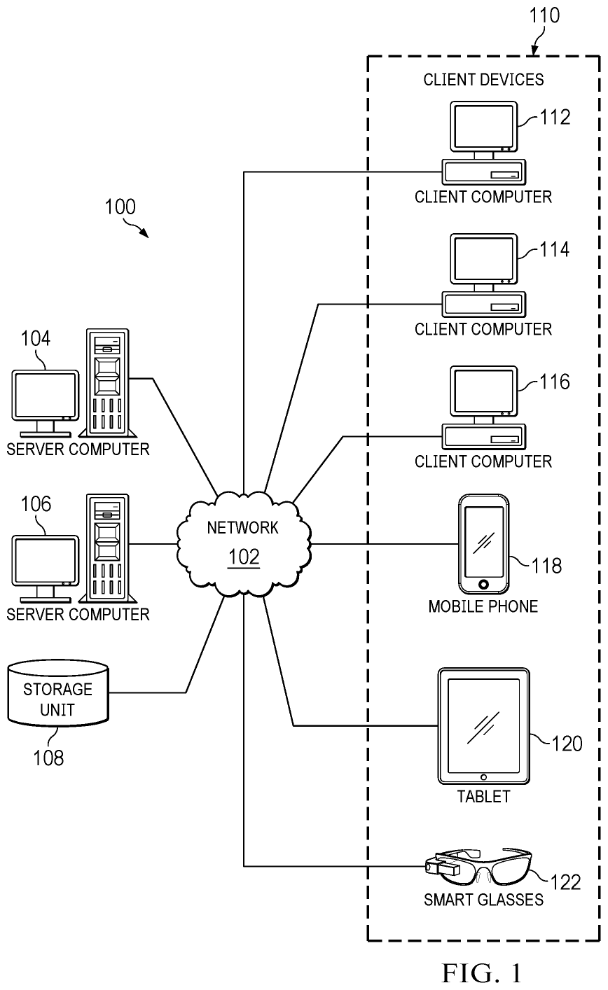

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

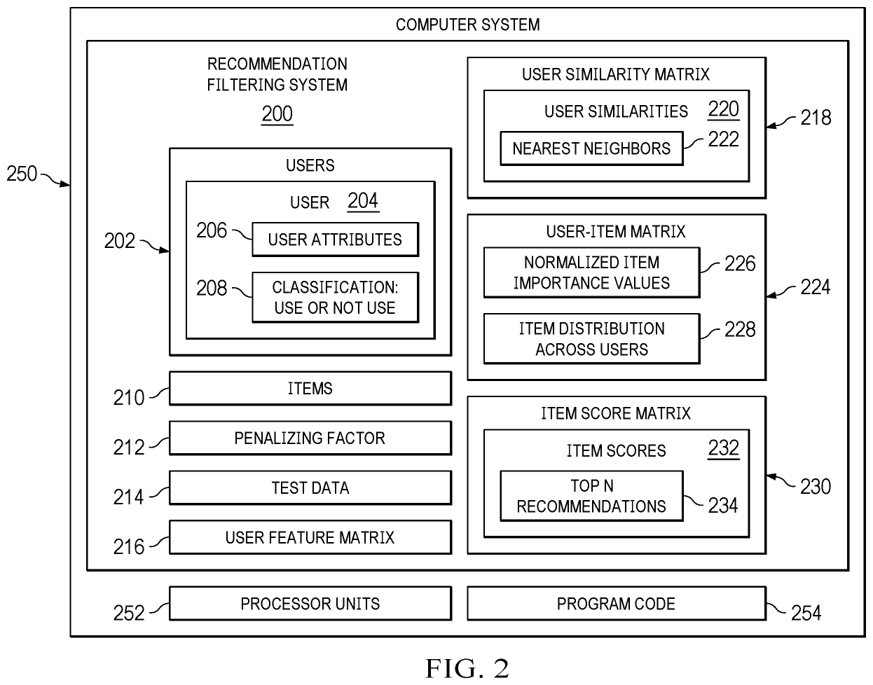

FIG. 2 is a block diagram of a document processing system for key-value extraction depicted in accordance with an illustrative embodiment. Recommendation filtering system 200 might be implemented in network data processing system 100 in FIG. 1.

Recommendation filtering system 200 recommends products to “cold” and new customers according to shallow data and accounting for lost customers. Cold customers are users/customers who have not previously expressed interest in or bought a product or service. Such customers may need to be educated and convinced about a particular product. Recommendation filtering system 200 uses information about a number of past users 202. Users 202 may represent accounts for individuals or businesses. Each user (account) 204 comprises a number of user attributes 206 and can be classified as using or not using particular items/products 210.

The user feature matrix 216 may be constructed with user vectors created using geographic components, predictive engagement scores (PES), small and medium sized enterprise (SME) scores, individual user attributes, and trial usage data. Geographic components may comprise, e.g., demographic clusters, wealth index, mortgage interest rates, savings interest rates, commercial real estate trend index, and local aggregated credit score. SME scores may comprise, e.g., closure risk score and original opportunity score. Individual user attributes may comprise, e.g., revenue, employee headcount, industry, ownership type, and business model. Trial usage data may comprise, e.g., number of users, number of datasets, number of products, and total adjusted hits.

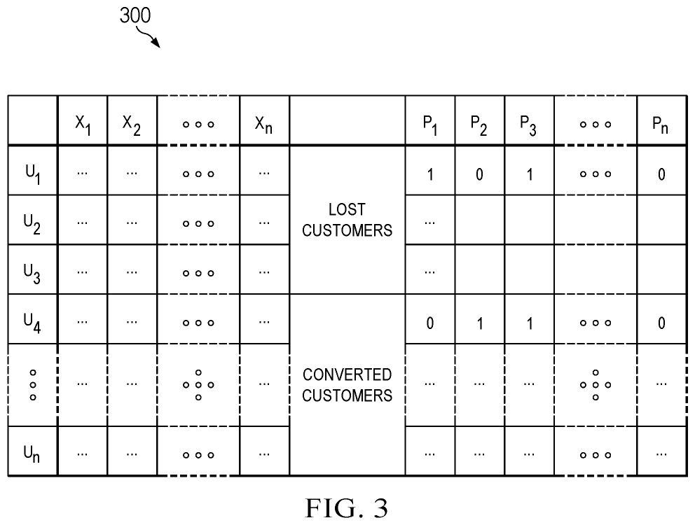

Recommendation filtering system 200 cross-references users 202 against user attributes 208 and items/products 210 in a user (account) feature matrix 216 (see FIG. 3).

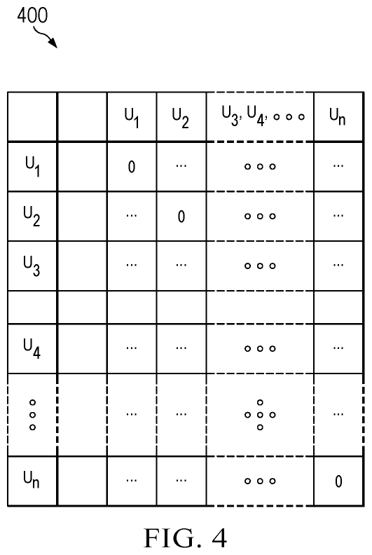

Recommendation filtering system 200 cross-references users 202 against each other in user similarity matrix 218 (see FIG. 4). Recommendation filtering system uses the user similarity matrix 218 to generate user similarities 220, which can be used to identify nearest neighbors 222. Gower distance may be used to calculate account similarity. No product information is used while computing user similarities 220. Gower distance has the advantage of allowing the use of mixed types of variables as well as missing values. Based on the user similarities 220, recommendation filtering system 200 is able to identify nearest neighbors (i.e., k-nearest neighbors) 222 of the users 202 clustered around particular attribute vectors.

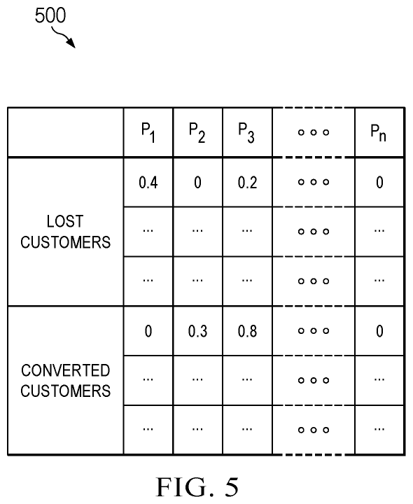

Recommendation filtering system 200 cross-references users 202 against items (products) 210 in a user-item matrix 224. Recommendation filtering system 200 replaces implicit feedback with normalized item (product) importance values 226, which are computed using item distribution across users (both lost and converted opportunities) (see FIG. 5).

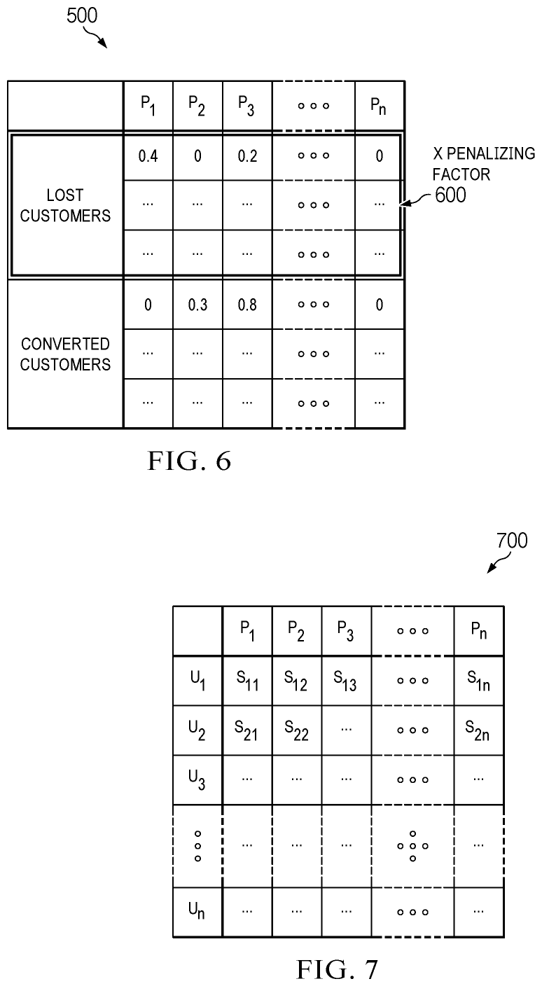

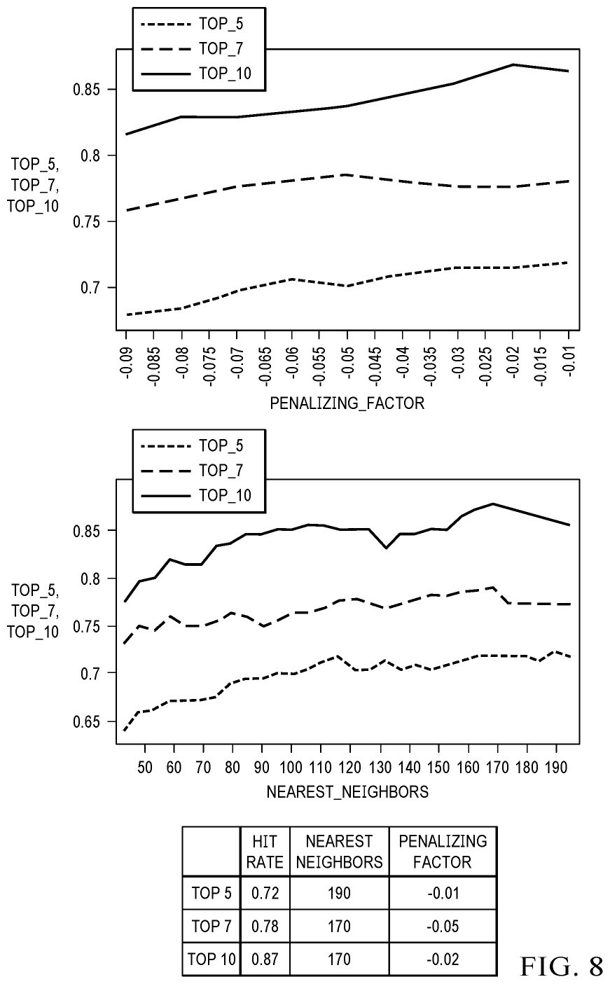

A penalizing factor 212 may be multiplied specifically against lost opportunities in the user-item matrix (see FIG. 6). The penalizing factor 212 is derived using a training loop which tries to maximize the hit ratio on the test data 214 using different ranges of penalizing factor from 0 to 1 and nearest neighbors 222 (see FIG. 8). In recommendation settings, the hit ratio is the fraction of users for which the correct answer is included in a recommendation list of length L. The larger L is, the higher the hit ratio becomes, because there is a higher chance that the correct answer is included in the recommendation list.

Recommendation filtering system 200 constructs an item (product) score matrix 230 (see FIG. 7) by multiplication between the user similarity matrix 218 and user-item matrix 224. Among the item scores 232, recommendation filtering system 200 may selected the top N recommendations 234. The top N recommendations 234 may be the top 5, top 7, top 10, etc. (equivalent to the length L of the recommendation list). During training of the recommendation filtering system 200, the top N recommendations 234 are compared against test data 214. The hyperparameters of nearest neighbors 222 and penalizing factor 212 are tuned to maximize the hit ratio of the top N recommendation 234 on the test data 214.

Recommendation filtering system 200 can be implemented in software, hardware, firmware, or a combination thereof. When software is used, the operations performed by recommendation filtering system 200 can be implemented in program code configured to run on hardware, such as a processor unit. When firmware is used, the operations performed by recommendation filtering system 200 can be implemented in program code and data and stored in persistent memory to run on a processor unit. When hardware is employed, the hardware can include circuits that operate to perform the operations in recommendation filtering system 200.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 250 is a physical hardware system and includes one or more data processing systems. When more than one data processing system is present in computer system 250, those data processing systems are in communication with each other using a communications medium. The communications medium can be a network. The data processing systems can be selected from at least one of a computer, a server computer, a tablet computer, or some other suitable data processing system.

As depicted, computer system 250 includes a number of processor units 252 that are capable of executing program code 254 implementing processes in the illustrative examples. As used herein a processor unit in the number of processor units 252 is a hardware device and is comprised of hardware circuits such as those on an integrated circuit that respond and process instructions and program code that operate a computer. When a number of processor units 252 execute program code 254 for a process, the number of processor units 252 is one or more processor units that can be on the same computer or on different computers. In other words, the process can be distributed between processor units on the same or different computers in a computer system. Further, the number of processor units 252 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

Thus, recommendation filing system 200 has processes with a practical application of making recommendations of items to users. For example, user similarity matrix 218 and user-item matrix 224 can be used to determine items scores 232. These item scores are used by recommendation filtering system 200 to select the top N recommendations 234 to form a recommendation list that can presented or given to a user such as a new user.

FIG. 3 depicts a diagram of a user feature matrix in accordance with an illustrative embodiment. User feature matrix 300 represents shallow data. Shallow data comprises limited datasets, which often provide difficultly in mathematical modelling due to the relatively low number of data points with which to make recommendations. By utilizing lost customers and opportunities within the datasets, the illustrative embodiments are able to overcome this shortcoming of shallow data and provide recommendations that would not be possible with prior approaches.

Lost customers are customers (users, accounts) who did not subscribe to or buy offered products. Converted customers are users who subscribed or bought products offered to them. U₁, U₂, . . . Uₙ represent each customer in the dataset. X₁, X₂, . . . Xₙ represent user attributes. P₁, P₂, . . . Pₙ represent products (items) for each customer.

FIG. 4 depicts a diagram of a user similarity matrix in accordance with an illustrative embodiment. User similarity matrix 400 comprises entries for users U₁, U₂, . . . Uₙ in the dataset in both the rows and columns. As mentioned above, Gower distance may be used to calculate user similarity. The range for Gower distance is from 0 to 1, wherein 1 represented a complete match, and 0 represents no match. A subset of the user attributes is used to compute the user similarity matrix 400.

FIG. 5 depicts a diagram of a user-item matrix in accordance with an illustrative embodiment. For the user-item matrix 500, the illustrative embodiments normalize implicit feedback using the product (item) distribution across cold and new customers.

FIG. 6 depicts application of a penalizing factor to the user-item matrix in accordance with an illustrative embodiment. The normalized product distribution for lost customers is multiplied by the penalizing factor 600. The normalized lost customer distribution is tuned during training by adjusting the penalizing factor 600.

FIG. 7 depicts a diagram of product score matrix in accordance with an illustrative embodiment. Product (item) scores S₁₁ . . . Sₙₙ are calculated for each customer through matrix multiplication between the user similarity matrix 400 and (penalized) user-item matrix 500 to product score matrix 700. S₁₁ represents the score given to product 1 for customer 1 and similarly for other customers as well, etc.

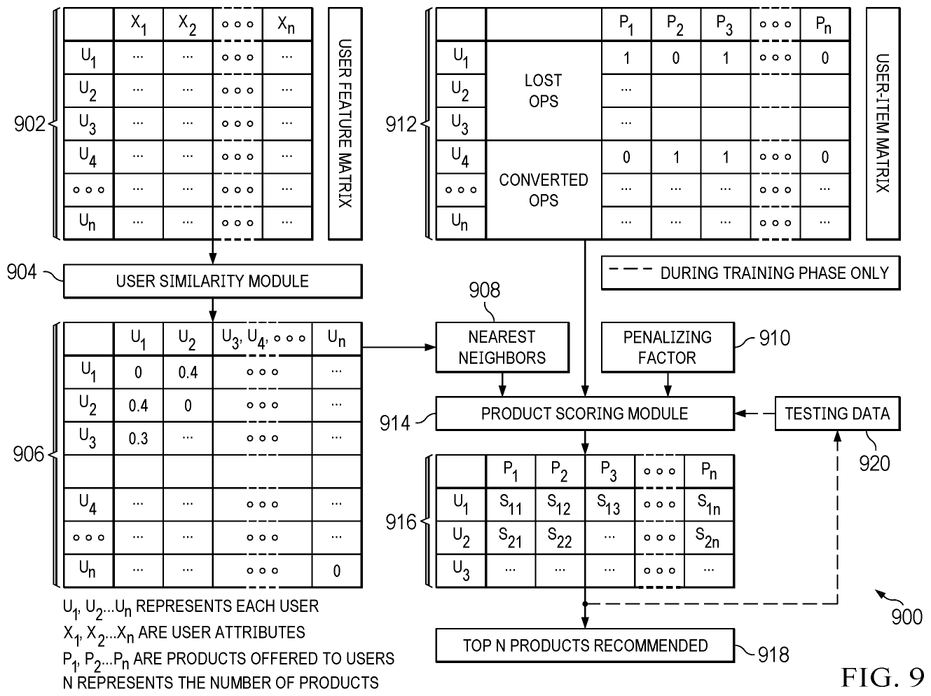

FIG. 9 depicts a diagram of a filtering algorithm in accordance with an illustrative embodiment.

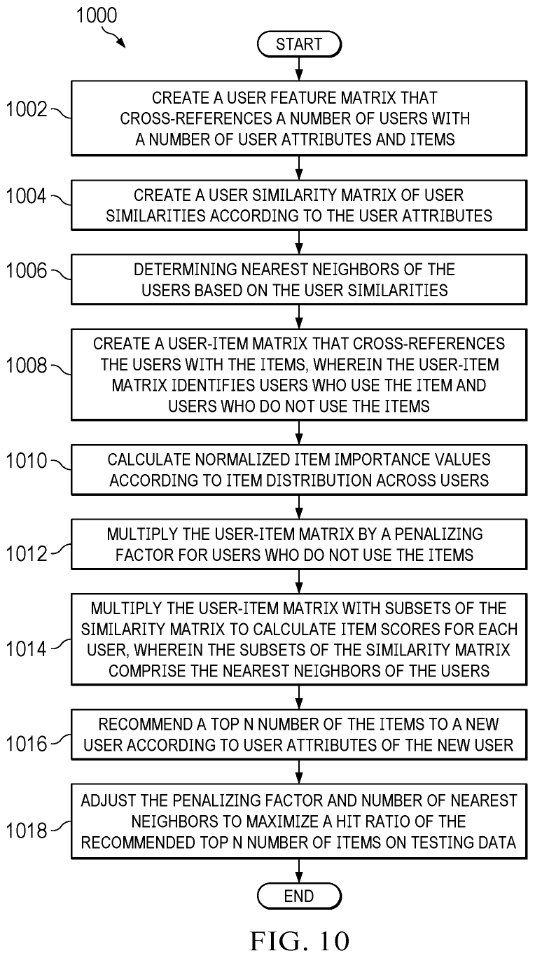

FIG. 10 depicts a flowchart illustrating a process for recommendation filtering in accordance with an illustrative embodiment. Process 1000 can be implemented in hardware, software, or both. When implemented in software, the process can take the form of program instructions that is run by one of more processor units located in one or more hardware devices in one or more computer systems. Process 1000 may be an example implementation of filtering algorithm 900 shown in FIG. 9 in recommendation filtering system 200 shown in FIG. 2.

Process 1000 begins by creating a user feature matrix 902 that cross-references a number of users with a number of user attributes and items (step 1002). User attributes in the user feature matrix 902 may comprise geographic components, predictive engagement scores, small and medium sized enterprise (SME) scores, individual user attributes, and trial usage data. Trial usage data may comprise the number of users, the number of datasets, the number of items, and total adjusted hits.

The system then creates a user similarity matrix of user similarities according to the user attributes (step 1004). The user similarities maybe determined according to a user similarity matrix 906 generated by a similarity module 904 employing Gower distance. Based on the user similarities, the system determines nearest neighbors of the users (step 1006).

The system creates a user-item matrix 912 that cross-references the users with the items, wherein the user-item matrix identifies users who use the item and users who do not use the items (step 1008). The system then calculates normalized item importance values according to item distribution across users (step 1010).

The system may employ a product scoring module 914 that multiplies the user-item matrix 912 by a penalizing factor 910 for users who do not use the items (i.e., lost customers) (step 1012).

An affinity factor calculated using the Gower distance determines how similar any two users are and is used to decide what percentage of weight a particular nearest neighbor products holds while recommending products. For example, in recommending products P₁, P₂, . . . Pₙ to a User u, the products' values have normalized weights (determined using the distribution of products across lost and converted opportunities) for each product for the user. After finding the similarity of User u to all other users via Gower distance, the nearest neighbors can be filtered and the products weights calculated

P₁,P₂, . . . Pₙ(u)=a₁*(P₁+P₂+ . . . +Pₙ)+a₂*(P₁+P₂+ . . . +Pₙ)+ . . . +aₘ*(P₁+P₂+ . . . +Pₙ) Eq. (1)

where m is the number of nearest neighbors and refers to the affinity or similarity between users, i.e., a₁ is the affinity of User u with User 1. Eq. (1) does not take into account the penalizing factor.

The system multiplies the user-item matrix 912 with subsets of the user similarity matrix 906 to calculate item scores for each user, which are presented in item score matrix 916 (step 1014) The subsets of the similarity matrix comprise the nearest neighbors 908 of the users. For each user, in the test data, the system recommends items/products according to the equation:

P₁,P₂, . . . Pₙ(u)=a₁*(pP₁+pP₂+ . . . +pPₙ)+a₂*(pP₁+pP₂+ . . . +pPₙ)+ . . . +aₘ*(P₁+P₂+ . . . +Pₙ) Eq. (2)

where p is the penalizing factor. The example in Eq. (2) assumes out of the nearest neighbors, User 1 and User 2 are lost customers/opportunities, and therefore the penalizing factor p is applied to them.

The system then recommends a top N number of the items (products) 918 to a new user according to user attributes of the new user (step 1016). During training, the filtering algorithm 900 is tuned by adjusting the penalizing factor 910 and number of nearest neighbors 908 to maximize the hit ratio of the recommended top N number of items 918 on testing data 920 (step 1018). Process 1000 then ends.

The formula for calculating the hit ratio in Eq. (3) below is used during training to arrive at the value for the penalizing factor and nearest neighbors.

$$HR = \frac{\vert {U}_{hit}^{N} \vert}{\vert {U}_{all} \vert} \qquad Eq . ( 3 )$$

where |Uₕᵢₜ^{N}| is the number of users for which the correct answer included in the top N recommendation list, and |Uₐₗₗ| is the total number of users in the test dataset.

As shown in FIG. 8 as N increases the higher the hit ratio becomes, because there is a higher chance that the correct answer is included in the recommendation list.

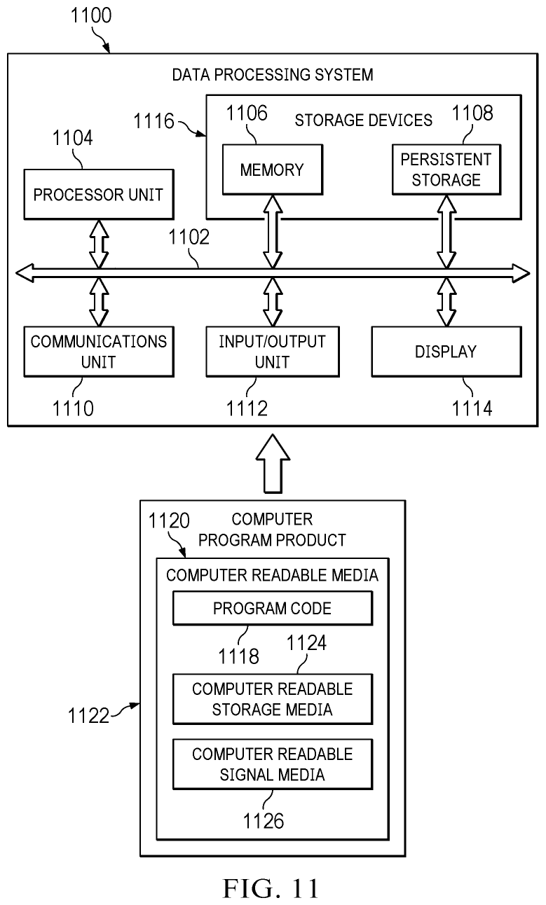

Turning now to FIG. 11, an illustration of a block diagram of a data processing system is depicted in accordance with an illustrative embodiment. Data processing system 1100 may be used to implement server computers 104 and 106 and client devices 110 in FIG. 1, as well as computer system 250 in FIG. 2. In this illustrative example, data processing system 1100 includes communications framework 1102, which provides communications between processor unit 1104, memory 1106, persistent storage 1108, communications unit 1110, input/output unit 1112, and display 1114. In this example, communications framework 1102 may take the form of a bus system.

Processor unit 1104 serves to execute instructions for software that may be loaded into memory 1106. Processor unit 1104 may be a number of processors, a multi-processor core, or some other type of processor, depending on the particular implementation. In an embodiment, processor unit 1104 comprises one or more conventional general-purpose central processing units (CPUs). In an alternate embodiment, processor unit 1104 comprises one or more graphical processing units (CPUs).

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108. Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer-usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1118 may be transferred to data processing system 1100 using computer-readable signal media 1126. Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for recommendation filtering, the method comprising:
using a number of processors to perform the steps of:
creating a user feature matrix that cross-references a number of users with a number of user attributes and items;
creating a user similarity matrix of user similarities according to the user attributes;
determining nearest neighbors of the users based the user similarities;
creating a user-item matrix that cross-references the users with the items, wherein the user-item matrix identifies users who use the item and users who do not use the items;
multiplying the user-item matrix by a penalizing factor for users who do not use the items;
multiplying the user-item matrix with subsets of the similarity matrix to calculate item scores for each user, wherein the subsets of the similarity matrix comprise the nearest neighbors of the users; and
recommending a top N number of the items to a new user based on the item scores according to user attributes of the new user.

2. The method of claim 1, further comprising calculating normalized item importance values.

3. The method of claim 1, wherein the user similarities are based on Gower distance.

4. The method of claim 1, wherein the user similarities are determined according to a user similarity matrix.

5. The method of claim 1, further comprising adjusting the penalizing factor and number of nearest neighbors to maximize a hit ratio of the recommended top N number of items on testing data.

6. The method of claim 1, wherein user attributes in the user feature matrix comprise at least one of:
geographic components;
predictive engagement scores;
small and medium sized enterprise (SME) scores;
individual user attributes; or
trial usage data.

7. The method of claim 6, wherein trial usage data comprises at least one of:
number of users;
number of datasets;
number of items; or
total adjusted hits.

8. A system for recommendation filtering, the system comprising:
a storage device configured to store program instructions; and
one or more processors operably connected to the storage device and configured to execute the program instructions to cause the system to:
create a user feature matrix that cross-references a number of users with a number of user attributes and items;
create a user similarity matrix of user similarities according to the user attributes;
determine nearest neighbors of the users based the user similarities;
create a user-item matrix that cross-references the users with the items, wherein the user-item matrix identifies users who use the item and users who do not use the items;
multiply the user-item matrix by a penalizing factor for users who do not use the items;
multiply the user-item matrix with subsets of the similarity matrix to calculate item scores for each user, wherein the subsets of the similarity matrix comprise the nearest neighbors of the users; and
recommend a top N number of the items to a new user based on the item scores according to user attributes of the new user.

9. The system of claim 8, wherein the processors further execute instructions to calculate normalized item importance values.

10. The system of claim 8, wherein the user similarities are based on Gower distance.

11. The system of claim 8, wherein the user similarities are determined according to a user similarity matrix.

12. The system of claim 8, wherein the processors further execute instructions to adjust the penalizing factor and number of nearest neighbors to maximize a hit ratio of the recommended top N number of items on testing data.

13. The system of claim 8, wherein user attributes in the user feature matrix comprise at least one of:
geographic components;
predictive engagement scores;
small and medium sized enterprise (SME) scores;
individual user attributes; or
trial usage data.

14. A computer program product for recommendation filtering, the computer program product comprising:
a computer-readable storage medium having program instructions embodied thereon to perform the steps of:
creating a user feature matrix that cross-references a number of users with a number of user attributes and items;
creating a user similarity matrix of user similarities according to the user attributes;
determining nearest neighbors of the users based the user similarities;
creating a user-item matrix that cross-references the users with the items, wherein the user-item matrix identifies users who use the item and users who do not use the items;
multiplying the user-item matrix by a penalizing factor for users who do not use the items;
multiplying the user-item matrix with subsets of the similarity matrix to calculate item scores for each user, wherein the subsets of the similarity matrix comprise the nearest neighbors of the users; and
recommending a top N number of the items to a new user based on the item scores according to user attributes of the new user.

15. The computer program product of claim 14, further comprising instructions for calculating normalized item importance values.

16. The computer program product of claim 14, wherein the user similarities are based on Gower distance.

17. The computer program product of claim 14, wherein the user similarities are determined according to a user similarity matrix.

18. The computer program product of claim 14, further comprising instructions for adjusting the penalizing factor and number of nearest neighbors to maximize a hit ratio of the recommended top N number of items on testing data.

19. The computer program product of claim 14, wherein user attributes in the user feature matrix comprise at least one of:
geographic components;
predictive engagement scores;
small and medium sized enterprise (SME) scores;
individual user attributes; or
trial usage data.

20. The computer program product of claim 19, wherein trial usage data comprises at least one of:
number of users;
number of datasets;
number of items; or
total adjusted hits.
